(19) United States
(12) Patent Application Publication
(10) Pub. No.: US 2026/0357389 A1
(43) Pub. Date: Nov. 12, 2026

(54) NON-ORIENTED ELECTRICAL STEEL SHEET

(71) Applicant: Hyundai Steel Company, Incheon (KR)

(72) Inventors: Min Sung Kim, Suwon-si (KR); Seong Tae Kim, Daegu (KR); Won Kee Chae, Daejeon (KR)

(21) Appl. No.: 19/719,436

(22) Filed: Jun. 25, 2026

Related U.S. Application Data
(63) Continuation of application No. PCT/KR2024/021183, filed on Dec. 26, 2024.

(30) Foreign Application Priority Data
Dec. 29, 2023 (KR) 10-2023-0197539

(51) Int. Cl. C22C 38/02; C21D 1/18; C21D 1/74; C21D 6/00; C21D 8/1205; C21D 8/1216; C21D 8/1244; C21D 9/46; C22C 38/00; C22C 38/04; C22C 38/06; C22C 38/14; H01F 1/147

(52) U.S. Cl. CPC C22C 38/02; C21D 1/18; C21D 1/74; C21D 6/005; C21D 6/008; C21D 8/1205; C21D 8/1222; C21D 8/1233; C21D 8/1261; C21D 9/46; C22C 38/001; C22C 38/002; C22C 38/004; C22C 38/005; C22C 38/04; C22C 38/06; C22C 38/14; H01F 1/14783; C22C 2202/02

(57) ABSTRACT

The present disclosure relates to a non-oriented electrical steel sheet and a manufacturing method therefor. In preferred aspects, according to the non-oriented electrical steel sheet and the manufacturing method therefor of the present disclosure, the non-oriented electrical steel sheet can have excellent magnetic properties due to improved crystallographic texture.

### CROSS-REFERENCE TO THE RELATED APPLICATIONS

This application is a continuation of International Application No. PCT/KR2024/021183 filed Dec. 26, 2024, which claims the benefit of Korean Patent Application No. 10-2023-0197539, filed Dec. 29, 2023, in the Ministry of Intellectual Property, the entire contents of which applications are incorporated herein by reference.

### FIELD

The present disclosure relates to a non-oriented electrical steel sheet.

### BACKGROUND

Recently, driven by policies aimed at reducing CO₂ emissions to prevent global warming, traditional internal combustion engine vehicles are being rapidly replaced by eco-friendly vehicles, such as hybrid electric vehicles (HEVs) or, in particular, electric vehicles (EVs). These electric vehicles (EVs) are required to produce high torque at low speeds or during acceleration, and perform high-speed rotation at or above 200 Hz during constant-speed and high-speed driving. For this reason, non-oriented electrical steel sheets, which are the iron core material for motors, must simultaneously satisfy both high magnetic flux density and low iron loss.

In general, non-oriented electrical steel sheets are manufactured through processes of steelmaking/continuous casting, hot rolling, intermediate annealing, cold rolling, final annealing, and coating, and can have excellent magnetic properties by optimizing each process condition.

To reduce iron loss in these non-oriented electrical steel sheets, methods such as reducing sheet thickness and improving electrical resistivity and crystallographic texture are employed.

Of these, crystallographic texture is one of the important factors for improving iron loss and magnetic flux density. That is, the crystallographic texture of non-oriented electrical steel sheets exerts a significant influence on their magnetic properties. In terms of crystallographic texture, the {001} plane is easily magnetized, whereas the {111} plane is unfavorable for magnetization. The smaller the presence of the {111} plane and the larger the presence of the {001} plane, the higher the magnetic flux density and the lower the iron loss can be. Due to this magnetocrystalline anisotropy, the magnetic flux density and iron loss in non-oriented electrical steel sheets are heavily dependent upon their crystallographic texture. However, if the volume fraction of the {111} plane in the crystallographic texture that is unfavorable for magnetization develops, a problem arises where magnetic properties are adversely affected.

Therefore, in order to solve these problems, there is a need for a non-oriented electrical steel sheet with magnetic properties enhanced by improving the crystallographic texture of the non-oriented electrical steel sheet, and a method of manufacturing the same.

### SUMMARY

In one aspect, it is an object of the present disclosure to provide a non-oriented electrical steel sheet having excellent magnetic properties by improving the crystallographic texture of the non-oriented electrical steel sheet, and a method of manufacturing the same.

In one aspect, a non-oriented electrical steel sheet of the present disclosure comprises, in weight percent: Si in an amount of a) 0.1% or greater and b) 1.6% or less; Mn in an amount of a) 0.1% or greater and b) 0.4% or less; μl in an amount a) greater than 0% and b) 0.5% or less; and at least one of B, Y, and Ce in an amount a) 0.005% or greater and b) 0.01% or less, with the balance being Fe and other unavoidable impurities, and satisfies General Formula 1 below.

$$0.5 \leq \frac{5 \times {f}_{( 001 ) < 130 >} + 3 \times {f}_{( 113 ) < 251 >}}{{f}_{( 334 ) < 483 >} + {f}_{( 111 ) < 110 >} + {f}_{( 11 \; 11 \; 9 ) < 99 \; 22 >}} \qquad [ General Formula 1 ]$$

In General Formula 1 above, f_{{001}<130>} denotes a volume fraction of a crystallographic texture having an orientation of 15° or less from {001}<130>, f_{{113}<251>} denotes a volume fraction of a crystallographic texture having an orientation of 15° or less from {113}<251>, f_{{334}<483>} denotes a volume fraction of a crystallographic texture having an orientation of 15° or less from {334}<483>, f_{{111}<110>} denotes a volume fraction of a crystallographic texture having an orientation of 15° or less from {111}<110>, and f_{{11 11 9}<9 9 22>} denotes a volume fraction of a crystallographic texture having an orientation of 15° or less from {11 11 9}<9 9 22>.

The f_{{111}<110>} may be 1.0% to 15.0%.

In addition, the non-oriented electrical steel sheet may further contain one or more selected from: C in an amount a) greater than 0% and b) 0.005% or less; S in an amount a) greater than 0% and b) 0.005% or less; P in an amount a) greater than 0% and b) 0.100% or less; N in an amount a) greater than 0% and b) 0.003% or less; and Ti in an amount a) greater than 0% and b) 0.005% or less, in weight percent.

The above weight percents are based on total weight of the steel sheet material. Unless otherwise indicated, weight percent of a component are in reference to or based on total weight of the sheet or other material.

In addition, for the non-oriented electrical steel sheet, an average of iron loss W_{15/50} measured at angles of 0° and 90° with respect to a rolling direction may be 8.0 W/kg or less.

In addition, for the non-oriented electrical steel sheet, an average of magnetic flux density (B₅₀) measured at angles of 0° and 90° with respect to a rolling direction may be 1.70 T or greater.

In addition, the non-oriented electrical steel sheet may further include a coating layer formed on a surface thereof.

According to preferred non-oriented electrical steel sheets of the present disclosure, excellent magnetic properties can be exhibited by improving the crystallographic texture.

In a further aspect, vehicles (including electric-powered vehicles) are provided that comprise a non-oriented electrical steel sheet as disclosed herein. In a further aspect, electric car driving motors are provided that comprise a non-oriented electrical steel sheet as disclosed herein.

It is understood that the term “vehicle” or “vehicular” or other similar term as used herein is inclusive of motor vehicles in general such as passenger automobiles comprising sports utility vehicles (SUV), buses, trucks, various commercial vehicles, watercraft comprising a variety of boats and ships, aircraft, and the like, and comprises hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### DETAILED DESCRIPTION

The present disclosure relates to a non-oriented electrical steel sheet, which is an iron core material used in motors that convert electrical energy into mechanical energy. The non-oriented electrical steel sheet satisfies General Formula 1 below.

$$0.5 \leq \frac{5 \times {f}_{( 001 ) < 130 >} + 3 \times {f}_{( 113 ) < 251 >}}{{f}_{( 334 ) < 483 >} + {f}_{( 111 ) < 110 >} + {f}_{( 11 \; 11 \; 9 ) < 99 \; 22 >}} \qquad [ General Formula 1 ]$$

In General Formula 1 above, f_{{001}<130>} denotes the volume fraction of a crystallographic texture having an orientation of 15° or less from {001}<130>; f_{{113}<251>} denotes the volume fraction of a crystallographic texture having an orientation of 15° or less from {113}<251>; f_{{334}<483>} denotes the volume fraction of a crystallographic texture having an orientation of 15° or less from {334}<483>; f_{{111}<110>} denotes the volume fraction of a crystallographic texture having an orientation of 15° or less from {111}<110>; and f_{{11 11 9}<99 22>} denotes the volume fraction of a crystallographic texture having an orientation of 15° or less from {11 11 9}<9 9 22>.

Specifically, the value calculated by the aforementioned General Formula 1 may be 0.5 or greater, and more specifically, may be 1.0 or greater. In this case, the upper limit of the value calculated by the aforementioned General Formula 1 is not particularly limited, but for example, may be 5.0 or less, or 4.0 or less. According to the non-oriented electrical steel sheet of the present application, by satisfying the aforementioned General Formula 1, excellent magnetic properties can be achieved, and specifically, low iron loss and high magnetic flux density can be attained. In contrast, if the value calculated by the aforementioned General Formula 1 falls below the lower limit of the aforementioned numerical range, the non-oriented electrical steel sheet may have its magnetic properties deteriorated.

In one example, the {001}<130> orientation of the crystallographic texture formed on the surface of the non-oriented electrical steel sheet is an orientation favorable for magnetic properties. For example, the f_{{001}<130>} may be 2.2% or greater. Specifically, the f_{{001}<130>} may be 2.4% or greater. In this case, the upper limit of the f_{{001}<130>} is not particularly limited, but may be 12% or less, or 10% or less, for example. By having the aforementioned volume fraction, the crystallographic texture having the {001}<130> orientation can exhibit excellent magnetic properties, and specifically, can exhibit low iron loss and high magnetic flux density.

In addition, the {113}<251> orientation of the crystallographic texture formed on the surface of the non-oriented electrical steel sheet is an orientation favorable for magnetic properties. For example, the f_{{113}<251>} may be 3.0% or greater. Specifically, the f_{{113}<251>} may be 3.2% or greater. In this case, the upper limit of the f_{{113}<251>} is not particularly limited, but may be 20% or less, or 18% or less, for example. By having the aforementioned volume fraction, the crystallographic texture having the {113}<251> orientation can exhibit excellent magnetic properties, and specifically, can exhibit low iron loss and high magnetic flux density.

In addition, the {334}<483> orientation of the crystallographic texture formed on the surface of the non-oriented electrical steel sheet is an orientation unfavorable for magnetic properties. For example, the f_{{334}<483}> may be 20.5% or less. Specifically, the f_{{334}<483>} may be 20.4% or less, 20.3% or less, or 20.2% or less. In this case, the lower limit of the f_{{334}<483}> is not particularly limited, but may be 1.0% or greater, 2.0% or greater, 3.0% or greater, or 4.0% or greater, for example. By having the aforementioned volume fraction, the crystallographic texture having the {334}<483> orientation can exhibit excellent magnetic properties, and specifically, can exhibit low iron loss and high magnetic flux density.

In addition, the {111}<110> orientation of the crystallographic texture formed on the surface of the non-oriented electrical steel sheet is an orientation unfavorable for magnetic properties. For example, the f_{{111}<110>} may be 1.0% to 15.0%. Specifically, the f_{{111}<110>} may have an upper limit of 14.5% or less, or 14.0% or less. In this case, the lower limit of the f_{{111}<110>} may be 1.0% or greater, 2.0% or greater, or 3.0% or greater. By having the aforementioned volume fraction, the crystallographic texture having the {111}<110> orientation can exhibit excellent magnetic properties, and specifically, can exhibit low iron loss and high magnetic flux density.

In addition, the {11 11 9}<9 9 22> orientation of the crystallographic texture formed on the surface of the non-oriented electrical steel sheet is an orientation unfavorable for magnetic properties. For example, the f_{{11 11 9}<9 9 22>} may be 10.0% or less. Specifically, the f_{{11 11 9}<9 9 22>} may be 8.5% or less, or 7.0% or less. In this case, the lower limit of the f_{{11 11 9}<9 9 22>} is not particularly limited, but may be 1.0% or greater, 2.0% or greater, or 3.0% or greater, for example. By having the aforementioned volume fraction, the crystallographic texture having the {11 11 9}<9 9 22> orientation can exhibit excellent magnetic properties, and specifically, can exhibit low iron loss and high magnetic flux density.

For the non-oriented electrical steel sheet, the average of the iron loss W_{15/50} measured at angles of 0° and 90° relative to the rolling direction, specifically, the rolling direction during cold rolling may be 8.0 W/kg or less. Specifically, for the non-oriented electrical steel sheet, the average of the iron loss W_{15/50} measured by the aforementioned method may be 7.0 W/kg or less. From the perspective that the lower the average of the iron loss W_{15/50} of the non-oriented electrical steel sheet, the better the magnetic properties are, its lower limit is not particularly restricted, but May 1 W/kg or greater, or 3 W/kg or greater, for example. The iron loss W_{15/50} refers to the iron loss when a magnetic flux density of 1.5 T is induced at a low frequency of 50 Hz. In this case, the iron loss W_{15/50} was measured with a Single Sheet Tester.

In addition, for the non-oriented electrical steel sheet, the average of the magnetic flux density (B₅₀) measured at angles of 0° and 90° relative to the rolling direction may be 1.70 T or greater. Specifically, for the non-oriented electrical steel sheet, the average of the magnetic flux density (B₅₀) measured by the aforementioned method may be 1.71 T or greater. Further, from the perspective that the higher the average of the magnetic flux density (B₅₀) of the non-oriented electrical steel sheet, the better the magnetic properties are, its upper limit is not particularly restricted, but may be 2.0 T or less, for example. The magnetic flux density (B₅₀) refers to the magnetic flux density induced in a magnetic field of 5000 A/m. In this case, the magnetic flux density was measured with a Single Sheet Tester.

In one example, the non-oriented electrical steel sheet may have a thickness of less than 0.7 mm. Further, the lower limit of the thickness of the non-oriented electrical steel sheet may be 0.01 mm or greater. By having the aforementioned thickness, the non-oriented electrical steel sheet can exhibit excellent magnetic properties, and specifically, can exhibit low iron loss and high magnetic flux density.

The non-oriented electrical steel sheet may contain, in weight percent (wt %): Si at 0.1% or greater and 1.6% or less; Mn at 0.1% or greater and 0.4% or less; Al at greater than 0% and 0.5% or less; and at least one of B, Y, and Ce at 0.005% or greater and 0.01% or less, with the balance being Fe and other unavoidable impurities.

The components of the non-oriented electrical steel sheet will be described below.

### Si: 0.1 wt % or Greater and 1.6 wt % or Less

Silicon (Si) is an element that reduces eddy current loss by increasing the electrical resistivity of the material. If the silicon is contained in the non-oriented electrical steel sheet in an amount below the lower limit of the aforementioned range, the effect of reducing iron loss may be insufficient. In addition, if the silicon is contained in the non-oriented electrical steel sheet in an amount exceeding the upper limit of the aforementioned range, magnetic permeability and magnetic flux density may decrease. Further, if the silicon is contained in the non-oriented electrical steel sheet within the aforementioned range, the crystallographic texture can be improved, thereby achieving a low iron loss value similar to that obtained with a high silicon content. Therefore, the silicon can be contained in the non-oriented electrical steel sheet in an amount of 0.1 wt % or greater and 1.6 wt % or less, and specifically, in an amount of 0.2 wt % or greater and 1.4 wt % or less.

### Mn: 0.1 wt % or Greater and 0.4 wt % or Less

Manganese (Mn) is an element that, together with Si, reduces iron loss by increasing electrical resistivity and improves the crystallographic texture. If the manganese is contained in the non-oriented electrical steel sheet in an amount exceeding the upper limit of the aforementioned range, coarse MnS may precipitate, thereby leading to a decrease in magnetic flux density and a deterioration in cold-rolling workability. In addition, if the manganese is contained in the non-oriented electrical steel sheet in an amount below the lower limit of the aforementioned range, fine MnS may precipitate, thereby inhibiting grain growth and increasing iron loss. Therefore, the manganese can be contained in the non-oriented electrical steel sheet in an amount of 0.1 wt % or greater and 0.4 wt % or less, and specifically, in an amount of 0.1 wt % or greater and 0.3 wt % or less.

Al: Greater than 0 wt % and 0.5 wt % or Less

Aluminum (Al) is an element that, together with Si, reduces eddy current loss by increasing electrical resistivity, and induces the precipitation of AlN by reacting with nitrogen (N). If the aluminum is contained in the non-oriented electrical steel sheet in an amount exceeding the upper limit of the aforementioned range, cold rolling workability may deteriorate, and magnetic flux density may decrease. Therefore, the aluminum can be contained in the non-oriented electrical steel sheet in an amount of greater than 0 wt % and 0.5 wt % or less, and specifically, in an amount of 0.001 wt % or greater and 0.4 wt % or less.

At least one of B, Y, and Ce: 0.005 wt % or greater and 0.01 wt % or less

Boron (B), yttrium (Y), and cerium (Ce) are elements that lower grain boundary energy through grain boundary segregation, reduce the volume fraction of orientations unfavorable for magnetic properties by suppressing the nucleation of the {111} and {112} orientations as the recrystallization rate decreases, and increase the {100} orientation and Goss orientation, which are favorable for magnetic properties. If at least one or more of the boron, yttrium, and cerium are contained in the non-oriented electrical steel sheet in an amount exceeding the upper limit of the aforementioned range, the pinning effect resulting from grain boundary segregation hinders the growth of recrystallized grains, and grain growth thus fails to occur, which instead exerts an adverse effect on the crystallographic texture. In addition, if at least one or more of the boron, yttrium, and cerium are contained in the non-oriented electrical steel sheet in an amount below the lower limit of the aforementioned range, this may be disadvantageous in terms of the crystallographic texture, and the magnetic properties may be inferior due to a low magnetic flux density. Therefore, at least one or more of the boron, yttrium, and cerium can be contained in the non-oriented electrical steel sheet in an amount of 0.005 wt % or greater and 0.01 wt % or less, and specifically, in an amount of 0.006 wt % or greater and 0.009 wt % or less.

### The Balance Fe and Other Unavoidable Impurities

The unavoidable impurities are impurities introduced during the steelmaking and manufacturing processes of the non-oriented electrical steel sheet, and since these are widely known in the art, detailed descriptions thereof will be omitted. In one embodiment of the present application, the addition of elements other than the aforementioned components of the non-oriented electrical steel sheet is not precluded, and such elements may be contained in various ways within a scope that does not compromise the technical concept of the present application. If additional elements are further contained, they may be contained in place of the balance iron (Fe).

For example, the unavoidable impurities may be zirconium (Zr), niobium (Nb), copper (Cu), or the like, and may contain Zr in an amount of 0.005 wt % or less, Nb in an amount of 0.005 wt % or less, and/or Cu in an amount of 0.005 wt % or less in the non-oriented electrical steel sheet.

In one example, the non-oriented electrical steel sheet may further contain one or more selected from: C at greater than 0% and 0.005% or less; S at greater than 0% and 0.005% or less; P at greater than 0% and 0.100% or less; N at greater than 0% and 0.003% or less; and Ti at greater than 0% and 0.005% or less, in weight percent (wt %).

C: Greater than 0 wt % and 0.005 wt % or Less

Carbon (C) is an element that can form carbides such as TiC and/or NbC by combining with other unavoidable impurities and can increase iron loss. If the carbon is contained in the non-oriented electrical steel sheet in an amount exceeding the upper limit of the aforementioned range, it may induce magnetic aging and adversely affect the magnetic properties. Therefore, the carbon can be contained in the non-oriented electrical steel sheet in an amount of greater than 0 wt % and 0.005 wt % or less, and specifically, in an amount of 0.001 wt % or greater and 0.003 wt % or less.

S: Greater than 0 wt % and 0.005 wt % or Less

Sulfur(S) is an element that combines with other unavoidable impurities and forms sulfides such as MnS and/or CuS, and if contained in an amount exceeding the upper limit of the aforementioned range, it may increase iron loss and inhibit grain growth. Therefore, the sulfur can be contained in the non-oriented electrical steel sheet in an amount of greater than 0 wt % and 0.005 wt % or less.

P: Greater than 0 wt % and 0.100 wt % or Less

Phosphorus (P) is a grain boundary segregation element and an element that develops crystallographic texture. If the phosphorus is contained in the non-oriented electrical steel sheet in an amount exceeding the upper limit of the aforementioned range, grain growth may be inhibited due to segregation effects, magnetic properties may deteriorate, and cold rolling workability may decrease. However, in terms of improving strength, the phosphorus can be contained in the non-oriented electrical steel sheet in an amount of greater than 0 wt % and 0.100 wt % or less.

N: Greater than 0 wt % and 0.003 wt % or Less

Nitrogen (N) is an element that combines with other unavoidable impurities and forms nitrides such as AlN, TiN, and/or NbN, and if contained in an amount exceeding the upper limit of the aforementioned range, it may increase iron loss and inhibit grain growth. Therefore, the nitrogen can be contained in the non-oriented electrical steel sheet in an amount of greater than 0 wt % and 0.003 wt % or less.

Ti: Greater than 0 wt % and 0.005 wt % or Less

Titanium (Ti) is an element that combines with other unavoidable impurities and forms fine carbides, nitrides, or the like, such as TiC and/or TiN, and if contained in an amount exceeding the upper limit of the aforementioned range, it may degrade magnetic properties by inhibiting grain growth. Therefore, the titanium can be contained in the non-oriented electrical steel sheet in an amount of greater than 0 wt % and 0.005 wt % or less.

In one example, the non-oriented electrical steel sheet may further include a coating layer. The coating layer is a coating formed on the surface of the non-oriented electrical steel sheet, and may be referred to as an insulating film. Since the insulating film is widely known, a detailed description thereof will be omitted. For example, the coating layer may be formed by applying a chromium-free (Cr-free) coating solution, i.e., an organic-inorganic composite coating solution containing no chromium, to the surface of the final annealed steel sheet, and then baking it. In this case, the coating layer may be formed with a thickness of 0.1 μm or greater and 5 μm or less. By further including the coating layer formed on its surface, the non-oriented electrical steel sheet can reduce eddy current loss by maintaining electrical insulation between the upper and lower non-oriented electrical steel sheets when the non-oriented electrical steel sheets are stacked in a plurality.

The non-oriented electrical steel sheet may have an average grain size of 80 μm or greater and 150 μm or less, and the deformation texture formed during cold rolling can be completely, i.e., 99% or greater, recrystallized through final annealing. For the non-oriented electrical steel sheet, if the average grain size falls below the lower limit of the aforementioned range, hysteresis loss may increase due to the fine grain size, and further, if it exceeds the upper limit of the aforementioned range, eddy current loss may increase, resulting in an increase in iron loss.

The present disclosure also relates to a method of manufacturing a non-oriented electrical steel sheet. The method of manufacturing a non-oriented electrical steel sheet relates to a method of manufacturing the aforementioned non-oriented electrical steel sheet, and specific details of a non-oriented electrical steel sheet to be described below will be omitted as the content described in the non-oriented electrical steel sheet above can be applied in the same manner.

The method of manufacturing a non-oriented electrical steel sheet of the present disclosure includes a step of manufacturing a hot-rolled steel sheet, a step of manufacturing a cold-rolled steel sheet, and a final annealing step, wherein the final annealed steel sheet satisfies General Formula 1 above. According to the method of manufacturing a non-oriented electrical steel sheet of the present application, the final annealed steel sheet can satisfy the aforementioned General Formula 1, and thus, can exhibit excellent magnetic properties, and specifically, can exhibit low iron loss and high magnetic flux density.

The step of manufacturing the hot-rolled steel sheet is a step for manufacturing a slab into a hot-rolled steel sheet, and is performed by reheating the slab and then hot rolling it. The reheating temperature for the slab is not particularly limited, but may be 1000 °C to 1250 °C, for example. If the reheating temperature for the slab falls below the lower limit of the aforementioned range, the rolling load increases, making it difficult to perform the hot rolling, and if it exceeds the upper limit of the aforementioned range, precipitates such as C, S, and N within the slab re-dissolve, leading to the formation of fine precipitates during subsequent rolling and annealing processes, which can inhibit grain growth and degrade magnetic properties.

In addition, the finish rolling temperature during the hot rolling may be 850 °C to 1000 °C, and specifically, may be 900 °C to 950 °C. By having the hot rolling performed under the aforementioned conditions, magnetic properties can be excellent. In contrast, if the finish rolling temperature during the hot rolling falls below the lower limit of the aforementioned range, fine TiC precipitates may form, which impede magnetic domain motion in the final material, thereby ultimately degrading its magnetic properties.

In addition, the thickness of the hot-rolled steel sheet may be 1.8 mm to 2.6 mm, and specifically, may be 2.0 mm to 2.5 mm, or 2.2 mm to 2.4 mm. If the thickness of the hot-rolled steel sheet exceeds the upper limit of the aforementioned range, the reduction ratio during cold rolling may increase, and crystallographic texture may thus be degraded. Therefore, the thickness of the hot-rolled steel sheet can be controlled to fall within the aforementioned range.

In one example, the slab may contain, in weight percent (wt %): Si at 0.1% or greater and 1.6% or less; Mn at 0.2% or greater and 0.4% or less; Al at greater than 0% and 0.5% or less; and at least one of B, Y, and Ce at 0.005% or greater and 0.01% or less, with the balance being Fe and other unavoidable impurities. A specific description of the components of the slab will be omitted as the content described in the non-oriented electrical steel sheet applies in the same manner.

In another example, the slab may further contain one or more selected from: C at greater than 0% and 0.005% or less; S at greater than 0% and 0.005% or less; P at greater than 0% and 0.100% or less; N at greater than 0% and 0.003% or less; and Ti at greater than 0% and 0.005% or less, in weight percent (wt %). Specific descriptions of the additional components added to the slab will be omitted as the content described in the non-oriented electrical steel sheet applies in the same manner.

In addition, the method of manufacturing a non-oriented electrical steel sheet may further include a coiling step. The coiling step is a step performed to increase orientations favorable for magnetic properties, and is performed by coiling onto a cylindrical coiling member.

In one example, the coiling step may be performed by coiling the hot-rolled steel sheet at a coiling temperature of 550 °C to 750 °C. As the coiling step is performed by coiling the hot-rolled steel sheet at the aforementioned coiling temperature, the grain size of the hot-rolled steel sheet during coiling can be made 40 μm to 100 μm, specifically, 40 μm to 60 μm, thereby reducing the load during cold rolling, the crystallographic texture can be improved to be favorable for magnetic properties during the final annealing after the cold rolling, and thus, the non-oriented electrical steel sheet, having undergone the final annealing, can satisfy the aforementioned General Formula 1. In contrast, if the coiling temperature of the hot-rolled steel sheet during the coiling step falls below the lower limit of the aforementioned range, the grains of the hot-rolled steel sheet will fail to grow, and fine grains or elongated grains will instead persist, leading to a deterioration in the magnetic properties of the final product. Further, if the coiling temperature of the hot-rolled steel sheet during the coiling step exceeds the upper limit of the aforementioned range, internal oxidation proceeds within the hot-rolled steel sheet, adversely affecting surface quality during the cold rolling, and precipitates such as TiC and/or TiN may form with sizes of 0.1 μm or less, leading to a deterioration in the magnetic properties of the final product. Therefore, the coiling step can be performed by coiling the hot-rolled steel sheet at the aforementioned coiling temperature.

In one example, the method of manufacturing a non-oriented electrical steel sheet may further include an intermediate annealing step. The intermediate annealing step is a step for increasing orientations favorable for magnetic properties, and can be performed by heat-treating the hot-rolled steel sheet.

In one example, the intermediate annealing step can be performed by heat-treating the hot-rolled steel sheet at 950 °C to 1100 °C for 30 to 120 seconds. Specifically, the intermediate annealing step can be performed by heating the hot-rolled steel sheet to 950 °C to 1100 °C at a heating rate of 20 °C/s or greater, and then heat-treating it in this temperature range for 30 to 120 seconds. In the intermediate annealing step, if the heat treatment temperature falls below the lower limit of the aforementioned range, there is insufficient time for grains to grow, causing fine grains to be formed, which may lead to a deterioration in the magnetic properties of the final product. On the other hand, in the intermediate annealing step, if the heat treatment temperature exceeds the upper limit of the aforementioned range, grains may grow excessively, resulting in large variations in grain size and increased oxidation, which may adversely affect the final product. Therefore, the intermediate annealing step can be performed at the aforementioned heat treatment temperature. Thereafter, the intermediate-annealed hot-rolled steel sheet can be cooled at a cooling rate of 30 °C/s or greater. In addition, the cooled hot-rolled steel sheet can then further undergo pickling. Thereby, the oxide layer formed on the surface of the hot-rolled steel sheet can be removed with a pickling solution.

The step of manufacturing the cold-rolled steel sheet is a step for manufacturing the intermediate-annealed hot-rolled steel sheet into a cold-rolled steel sheet, and is performed through cold rolling. In this case, the thickness of the cold-rolled steel sheet may be 0.70 mm or less, and specifically, may be 0.60 mm or less. In addition, the lower limit of the thickness of the cold-rolled steel sheet may be 0.10 mm or greater, or 0.30 mm or greater. In this case, the reduction ratio during the cold rolling may be 70% to 90%.

The final annealing step is a step for ensuring magnetic properties by growing grains to a particular size, and is performed by heat-treating the cold-rolled steel sheet. For example, the final annealing can be performed by heating to 800 °C to 1000 °C at a heating rate of 10 °C/s or greater, heat-treating in this temperature range for 5 to 70 seconds, and then cooling at a cooling rate of 20 °C/s or greater. By having the final annealing step performed in the aforementioned ranges of heating rate, temperature, duration, and cooling rate, iron loss can be reduced, and an optimal grain size that takes mechanical properties into account can be derived. In contrast, if the heating rate, temperature, and duration in the final annealing step exceed the upper limits of the aforementioned ranges, the grain size may become coarser, thereby causing an increase in eddy current loss. Further, if the heating rate, temperature, and duration in the final annealing step fall below the lower limits of the aforementioned ranges, the grain size may become finer, thereby causing an increase in hysteresis loss.

In this case, the final annealing step can be performed in an atmosphere of 0% to 100% hydrogen and 0% to 100% nitrogen, specifically, 20% to 40% hydrogen and 60% to 80% nitrogen. By having the final annealing step performed under the atmosphere within the aforementioned ranges, the method of manufacturing a non-oriented electrical steel sheet allows the surface condition of the steel sheet to be smoother.

In the non-oriented electrical steel sheet, the average size of the grains formed on the surface in the final annealing process can be 80 μm to 150 μm, and the deformation texture formed in the preceding cold rolling step can be completely, i.e., 99% or greater, recrystallized. For the non-oriented electrical steel sheet, if the average size of the grains in the final annealing process falls below the lower limit of the aforementioned range, hysteresis loss may increase due to the fine grain size, and further, if it exceeds the upper limit of the aforementioned range, eddy current loss may increase, thereby causing an increase in iron loss.

In another example, the method of manufacturing a non-oriented electrical steel sheet may further include a step of forming a coating layer. The step of forming the coating layer can be performed on the surface of the final annealed steel sheet, and specifically, can be performed by forming a coating layer on the surface of the steel sheet on which heat treatment has been performed during the final annealing. A specific description of the coating layer is the same as that provided for the non-oriented electrical steel sheet above, and will thus be omitted.

In the following, the present disclosure will be described in greater detail through embodiments according to the present disclosure and comparative examples not according to the present application, but the scope of the present disclosure is not limited by the embodiments presented below.

### Embodiment 1

### Manufacture of Non-Oriented Electrical Steel Sheet

A slab was manufactured by steelmaking and continuous casting with the components shown in Table 1 below, along with the balance Fe and other unavoidable impurities, reheated at a temperature of 1120 °C, and then hot-rolled with a finishing temperature of 920 °C, thereby manufacturing a hot-rolled steel sheet with a thickness of 2.3 mm.

Thereafter, the hot-rolled steel sheet was coiled at a coiling temperature of 680 °C.

Thereafter, the hot-rolled steel sheet was cold-rolled with a reduction ratio of approximately 78%, thereby manufacturing a cold-rolled steel sheet with a thickness of 0.5 mm.

Thereafter, the cold-rolled steel sheet was heated to 1000 °C at a heating rate of 20 °C/s in a mixed atmosphere of 30% hydrogen and 70% nitrogen, held at this temperature for 60 seconds, then cooled at a cooling rate of 30 °C/s, and final annealed, thereby manufacturing a non-oriented electrical steel sheet.

TABLE 1
Slab composition (wt %)

| Si | Mn | Al | C | S | P | N | Ti | B | Y | Ce |
|---|---|---|---|---|---|---|---|---|---|---|
| 0.27 | 0.141 | 0.001 | 0.0015 | 0.0044 | 0.0780 | 0.0015 | 0.0007 | 0.0020 | 0.0010 | 0.0030 |

### Embodiments 2 to 9 and Comparative Examples 1 to 5

### Manufacture of Non-Oriented Electrical Steel Sheets

Each non-oriented electrical steel sheet was manufactured in the same method as in Embodiment 1, except that the composition of the slab was modified as in Table 2 below.

TABLE 2
Slab composition (wt %)

| | Si | Mn | Al | C | S | P | N | Ti | B | Y | Ce |
|---|---|---|---|---|---|---|---|---|---|---|---|
| Embodiment 2 | 0.35 | 0.253 | 0.001 | 0.0025 | 0.0041 | 0.0620 | 0.0014 | 0.0008 | 0.0015 | 0.0022 | 0.0025 |
| Embodiment 3 | 0.72 | 0.250 | 0.293 | 0.0013 | 0.0045 | 0.0090 | 0.0011 | 0.0020 | 0.0010 | 0.0025 | 0.0040 |
| Embodiment 4 | 0.92 | 0.350 | 0.211 | 0.0029 | 0.0034 | 0.0350 | 0.0014 | 0.0013 | 0.0015 | 0.0040 | 0.0030 |
| Embodiment 5 | 0.84 | 0.302 | 0.237 | 0.0027 | 0.0033 | 0.0210 | 0.0021 | 0.0009 | 0.0040 | 0.0020 | 0.0025 |
| Embodiment 6 | 1.25 | 0.250 | 0.347 | 0.0014 | 0.0033 | 0.0090 | 0.0014 | 0.0005 | 0.0005 | 0.0020 | 0.0050 |
| Embodiment 7 | 1.27 | 0.218 | 0.001 | 0.0016 | 0.0022 | 0.0800 | 0.0012 | 0.0025 | 0.0053 | 0.0012 | 0.0025 |
| Embodiment 8 | 1.32 | 0.212 | 0.03 | 0.0012 | 0.0018 | 0.0750 | 0.0015 | 0.0020 | 0.0055 | 0.0010 | 0.0030 |
| Embodiment 9 | 1.28 | 0.200 | 0.03 | 0.0018 | 0.0022 | 0.0800 | 0.0012 | 0.0025 | 0.0053 | 0.0012 | 0.0025 |
| Comparative | 0.33 | 0.200 | 0.001 | 0.0020 | 0.0040 | 0.0700 | 0.0015 | 0.0007 | 0.0050 | 0.0025 | 0.0035 |
| Example 1 | | | | | | | | | | | |
| Comparative | 0.72 | 0.300 | 0.001 | 0.0015 | 0.0050 | 0.0680 | 0.0013 | 0.0008 | 0.0022 | 0.0030 | 0.0055 |
| Example 2 | | | | | | | | | | | |
| Comparative | 0.93 | 0.210 | 0.223 | 0.0013 | 0.0038 | 0.0230 | 0.0011 | 0.0010 | 0.0036 | 0.0065 | 0.0020 |
| Example 3 | | | | | | | | | | | |
| Comparative | 1.29 | 0.222 | 0.305 | 0.0015 | 0.0030 | 0.0100 | 0.0013 | 0.0009 | 0.0065 | 0.0015 | 0.0024 |
| Example 4 | | | | | | | | | | | |
| Comparative | 1.25 | 0.230 | 0.253 | 0.0010 | 0.0035 | 0.0120 | 0.0015 | 0.0010 | 0.0012 | 0.0025 | 0.0011 |
| Example 5 | | | | | | | | | | | |

### Evaluation Example 1: Evaluation of Whether General Formula 1 is Satisfied

For the non-oriented electrical steel sheets manufactured in each of the embodiments and comparative examples, the crystal orientations of the crystallographic texture were measured over an area of 1000 μm×1000 μm or greater using electron backscatter diffraction (EBSD), the volume fractions of the {001}<130>, {113}<251>, {334}<483>, {111}<110>, and {11 11 9}<9 9 22> orientations were calculated by General Formula 1 below, it was then evaluated whether General Formula 1 below was satisfied, and the results are presented in Table 3 below.

$$0.5 \leq \frac{5 \times {f}_{( 001 ) < 130 >} + 3 \times {f}_{( 113 ) < 251 >}}{{f}_{( 334 ) < 483 >} + {f}_{( 111 ) < 110 >} + {f}_{( 11 \; 11 \; 9 ) < 99 \; 22 >}} \qquad [ General Formula 1 ]$$

In General Formula 1 above, f {001}<130> denotes the volume fraction of a crystallographic texture having an orientation of 15° or less from {001}<130>; f {113}<251> denotes the volume fraction of a crystallographic texture having an orientation of 15° or less from {113}<251>; f {334}<483> denotes the volume fraction of a crystallographic texture having an orientation of 15° or less from {334}<483>; f {111}<110> denotes the volume fraction of a crystallographic texture having an orientation of 15° or less from {111}<110>; and f {11 11 9}<9 9 22> denotes the volume fraction of a crystallographic texture having an orientation of 15° or less from {11 11 9}<9 9 22>.

### Evaluation Example 2: Evaluation of Iron Loss and Magnetic Flux Density

After manufacturing specimens by cutting the non-oriented electrical steel sheets manufactured in each of the embodiments and comparative examples into 60 mm in width by 60 mm in length, the iron loss W_{15/50} and magnetic flux density (B₅₀) were measured twice (on the top and bottom surfaces of the specimens) at an angle of 0° and twice (on the top and bottom surfaces of the specimens) at an angle of 90° relative to the rolling direction during cold rolling with a Single Sheet Tester, and their average values are presented in Table 3 below. In this case, W 15/50 refers to the iron loss when a magnetic flux density of 1.5 T is induced at a low frequency of 50 Hz, and B₅₀ refers to the magnetic flux density induced in a magnetic field of 5000 A/m.

TABLE 3

| | At least one | | | | | | Value | | |
|---|---|---|---|---|---|---|---|---|---|
| | of B, Y and | Volume fraction of crystallographic texture(%) | | | | | calculated | | |
| | Ce | {001} | {113} | {334} | {11 11 9} | {111} | by General | W_{15/50} | B₅₀ |
| | (wt %) | <130> | <251> | <483> | <9 9 22> | <110> | Formula 1 | (W/kg) | (T) |
| Embodiment 1 | 0.0060 | 8.5 | 15.8 | 17.3 | 4.4 | 9.1 | 2.92 | 6.16 | 1.75 |
| Embodiment 2 | 0.0062 | 2.4 | 4.2 | 4.7 | 6.2 | 8.3 | 1.28 | 5.82 | 1.75 |
| Embodiment 3 | 0.0075 | 5.6 | 13.3 | 19.1 | 5.3 | 13.9 | 1.77 | 5.17 | 1.74 |
| Embodiment 4 | 0.0085 | 2.7 | 5.0 | 4.2 | 4.9 | 7.4 | 1.73 | 5.09 | 1.74 |
| Embodiment 5 | 0.0085 | 4.4 | 5.2 | 5.0 | 4.1 | 3.6 | 2.96 | 4.70 | 1.75 |
| Embodiment 6 | 0.0075 | 5.1 | 16.9 | 20.2 | 6.2 | 12.8 | 1.94 | 4.03 | 1.73 |
| Embodiment 7 | 0.0075 | 3.3 | 3.2 | 4.0 | 4.0 | 7.4 | 1.69 | 4.03 | 1.71 |
| Embodiment 8 | 0.0095 | 9.12 | 13.5 | 12.8 | 3.5 | 5.3 | 3.99 | 3.8 | 1.72 |
| Embodiment 9 | 0.0090 | 8.5 | 13 | 13.8 | 4.2 | 4.8 | 3.57 | 3.99 | 1.72 |
| Comparative | 0.0110 | 1.2 | 0.9 | 34.0 | 15.8 | 18.2 | 0.13 | 15.00 | 1.72 |
| Example 1 | | | | | | | | | |
| Comparative | 0.0107 | 0.8 | 3.3 | 28.5 | 13.5 | 13.8 | 0.25 | 12.25 | 1.70 |
| Example 2 | | | | | | | | | |
| Comparative | 0.0121 | 1.5 | 4.5 | 22.5 | 15.2 | 15.6 | 0.39 | 10.85 | 1.70 |
| Example 3 | | | | | | | | | |
| Comparative | 0.0104 | 2.0 | 3.2 | 20.8 | 11.2 | 10.2 | 0.46 | 8.28 | 1.68 |
| Example 4 | | | | | | | | | |
| Comparative | 0.0038 | 0.7 | 0.5 | 21.2 | 10.5 | 8.2 | 0.13 | 9.52 | 1.67 |
| Example 5 | | | | | | | | | |

As shown in Table 3 above, it has been confirmed that the non-oriented electrical steel sheets manufactured in each of Embodiments 1 to 9 simultaneously exhibit low iron loss and high magnetic flux density, as they satisfy General Formula 1 and the content of at least one of B, Y, and Ce falls within a particular range. In contrast, it has been confirmed that the non-oriented electrical steel sheets manufactured in each of Comparative Examples 1 to 4 fail to simultaneously exhibit low iron loss and high magnetic flux density, as they do not satisfy General Formula 1 and the content of at least one of B, Y, and Ce exceeds the particular range. Further, it has been confirmed that the non-oriented electrical steel sheet manufactured in Comparative Example 5 fails to simultaneously exhibit low iron loss and high magnetic flux density, as it does not satisfy General Formula 1 and the content of at least one of B, Y, and Ce falls below the particular range.

What is claimed:

1. A non-oriented electrical steel sheet comprising, in weight percent: Si in an amount of a) 0.1% or greater and b) 1.6% or less; Mn in an amount of a) 0.1% or greater and b) 0.4% or less; Al in an amount of a) greater than 0% and b) 0.5% or less; and at least one of B, Y, and Ce in an amount of a) 0.005% or greater and b) 0.01% or less, with the balance being Fe and other unavoidable impurities, and satisfying General Formula 1 below:
$$0.5 \leq \frac{5 \times {f}_{( 001 ) < 130 >} + 3 \times {f}_{( 113 ) < 251 >}}{{f}_{( 334 ) < 483 >} + {f}_{( 111 ) < 110 >} + {f}_{( 11 \; 11 \; 9 ) < 99 \; 22 >}} , \qquad [ General Formula 1 ]$$
wherein, in General Formula 1 above, f_{{001}<130>} denotes a volume fraction of a crystallographic texture having an orientation of 15° or less from {001}<130>, f_{{113}<251>} denotes a volume fraction of a crystallographic texture having an orientation of 15° or less from {113}<251>, f_{{334}<483>} denotes a volume fraction of a crystallographic texture having an orientation of 15° or less from {334}<483>, f_{{111}<110>} denotes a volume fraction of a crystallographic texture having an orientation of 15° or less from {111}<110>, and f_{{11 11 9}<99 22>} denotes a volume fraction of a crystallographic texture having an orientation of 15° or less from {11 11 9}<9 9 22>.

2. The non-oriented electrical steel sheet of claim 1, wherein the f_{{111}<110>} is 1.0% to 15.0%.

3. The non-oriented electrical steel sheet of claim 1, further comprising one or more selected from:
C in an amount of a) greater than 0% and b) 0.005% or less; S in an amount of a) greater than 0% and b) 0.005% or less; P in an amount of a) greater than 0% and b) 0.100% or less; N in an amount of ga) greater than 0% and b) 0.003% or less; and Ti in an amount oft a) greater than 0% and b) 0.005% or less, in weight percent.

4. The non-oriented electrical steel sheet of claim 1, wherein an average of iron loss W_{15/50} measured at angles of 0° and 90° with respect to a rolling direction is 8.0 W/kg or less.

5. The non-oriented electrical steel sheet of claim 1, wherein an average of magnetic flux density (B₅₀) measured at angles of 0° and 90° with respect to a rolling direction is 1.70 T or greater.

6. The non-oriented electrical steel sheet of claim 1, further comprising:
a coating layer formed on a surface thereof.
